(19) United States
(12) Patent Application Publication
(10) Pub. No.: US 2019/0344842 A1
(43) Pub. Date: Nov. 14, 2019

(54) RUBBER CRAWLER, RUBBER CRAWLER MOLD, AND METHOD OF PRODUCING RUBBER CRAWLER

(71) Applicant: BRIDGESTONE CORPORATION, Chuo-ku Tokyo (JP)

(72) Inventors: Takashi MIZUSAWA, Yokohama-shi, Kanagawa (JP); Shoko NAGAMOTO, Chuo-ku, Tokyo (JP)

(73) Assignee: BRIDGESTONE CORPORATION, Chuo-ku Tokyo (JP)

(21) Appl. No.: 16/475,450

(22) PCT Filed: Jan. 19, 2018
(86) PCT No.: PCT/JP2018/001661

§ 371 Date: Jul. 2, 2019

(30) Foreign Application Priority Data
Jan. 20, 2017 (JP) 2017-008914

(51) Int. Cl. B62D 55/24; B62D 55/26; B29D 29/00; B29C 33/10

(52) U.S. Cl. CPC B62D 55/244; B29C 33/10; B29D 29/00; B62D 55/26

(57) ABSTRACT

A rubber crawler (10) includes an endless rubber elastic body and protruding lugs (11) formed on the outer peripheral surface at a predetermined pitch in the crawler peripheral direction. Minute protrusions (14) extending in a direction intersecting the crawler width direction when viewed from the crawler peripheral direction are formed on a first side surface (12a) and a second side surface (12b) of the lugs (11), the side surfaces (12a, 12b) facing the crawler peripheral direction.

### TECHNICAL FIELD

The present disclosure relates to a rubber crawler, a rubber crawler mold, and a method of producing a rubber crawler.

### BACKGROUND

A plurality of lugs protrude from the ground contact surface of a rubber crawler that is made of an endless rubber elastic body and mounted on a vehicle used in construction, civil engineering, farming, and the like. The lugs are arranged in various lug patterns in accordance with use.

A rubber crawler is formed by, for example, positioning an unvulcanized rubber member between an upper mold piece and lower mold piece of a mold, pressing with the upper mold piece, and vulcanizing the lug surface. When the lug shape is complex, however, molding defects easily occur during molding due to air trapping, in which air inside the mold is not released.

To address this, a rubber crawler is typically formed by providing vent ridges for air release at the top surface of the lugs, releasing air by also splitting the mold at the top surface, and vulcanizing. Patent literature (PTL) 1 proposes an example of such vulcanization molding.

### CITATION LIST

### Patent Literature

PTL 1: JPS57-152936A

### SUMMARY

### Technical Problem

The distance from the bottom of the lug to the top surface grows long in a large-scale rubber crawler in which the lugs protrude from the lug surface to a large height. Therefore, even with vulcanization molding in which vent ridges for air release are provided at the top surface of the lug as in the aforementioned conventional technique, the long distance may prevent air in the mold from being released at the time of vulcanization, causing molding defects.

It is therefore an objective of the present disclosure to provide a rubber crawler, a rubber crawler mold, and a method of producing a rubber crawler that can reliably release air from inside a mold at the time of vulcanization molding and that can suppress molding defects occurring due to air not being released.

### Solution to Problem

To achieve the aforementioned object, a rubber crawler according to the present disclosure includes an endless rubber elastic body and protruding lugs formed on an outer peripheral surface at a predetermined pitch in the crawler peripheral direction. Minute protrusions extending in a direction intersecting the crawler width direction when viewed from the crawler peripheral direction are formed on a side surface of the lugs, the side surface facing the crawler peripheral direction.

To achieve the aforementioned object, a rubber crawler mold according to the present disclosure includes an upper mold piece and a lower mold piece and is for obtaining a rubber crawler by placing an unvulcanized rubber member that includes a lug surface between the upper mold piece and the lower mold piece, pressing the upper mold piece and the unvulcanized rubber member relative to each other, and vulcanizing the lug surface. The upper mold piece includes lug molding blocks for forming protruding lugs on the lug surface, the lug molding blocks include lug side-surface forming portions for forming side surfaces of the lugs, the side surfaces facing a crawler peripheral direction, and minute recesses are provided on the lug side-surface forming portions.

To achieve the aforementioned object, a method according to the present disclosure is for producing a rubber crawler including an endless rubber elastic body and protruding lugs formed on an outer peripheral surface at a predetermined pitch in a crawler peripheral direction. The method includes placing an unvulcanized rubber member that includes a lug surface between the upper mold piece and the lower mold piece of the rubber crawler mold of the present disclosure, pressing the upper mold piece and the unvulcanized rubber member relative to each other, and vulcanizing the lug surface to obtain the rubber crawler.

### Advantageous Effect

The present disclosure can provide a rubber crawler, a rubber crawler mold, and a method of producing a rubber crawler that can reliably release air from inside a mold at the time of vulcanization molding and that can suppress molding defects occurring due to air not being released.

### BRIEF DESCRIPTION OF THE DRAWINGS

In the accompanying drawings:

FIG. 1A is a perspective view illustrating, from the ground contact surface side, a portion cut in the crawler peripheral direction of a rubber crawler according to an embodiment of the present disclosure;

FIG. 1B is a plan view illustrating, from the ground contact surface side, a portion cut in the crawler peripheral direction of a rubber crawler according to an embodiment of the present disclosure;

FIG. 2A is a partial enlarged view illustrating an enlargement of portion X of FIG. 1B;

FIG. 2B is a cross-sectional view along line B-B of FIG. 2A, illustrating an enlargement of portion X of FIG. 1B;

FIG. 3 is a cross-sectional view along line A-A of FIG. 1B;

FIG. 4A is a partial enlarged view illustrating an enlargement of portion Y of FIG. 1B;

FIG. 4B is a cross-section along line A-A of FIG. 4A, illustrating an enlargement of portion Y of FIG. 1B; and

FIG. 5 is a partial cross-section illustrating an upper mold piece and a lower mold piece of a rubber crawler mold according to an embodiment of the present disclosure.

### DETAILED DESCRIPTION

An embodiment of the present disclosure is described below with reference to the drawings.

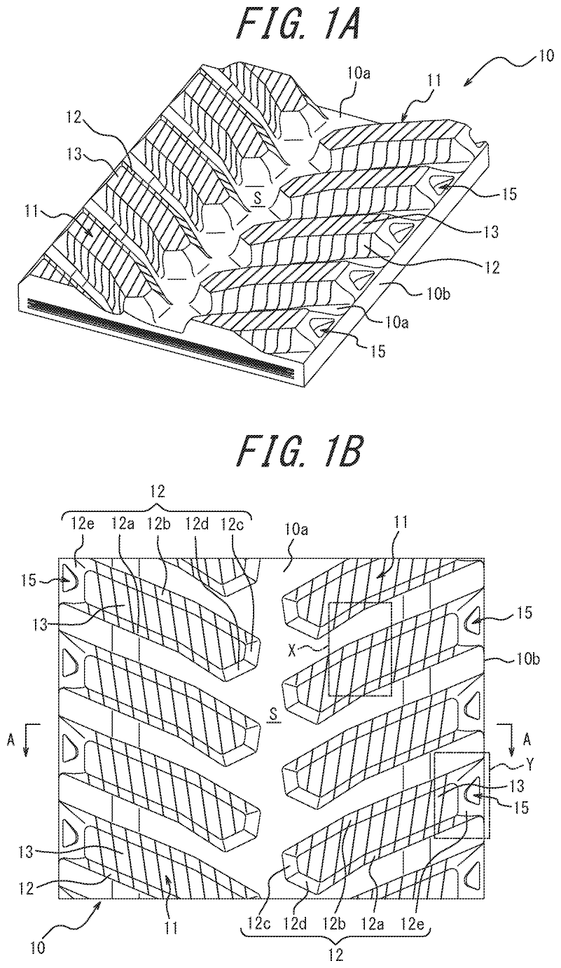

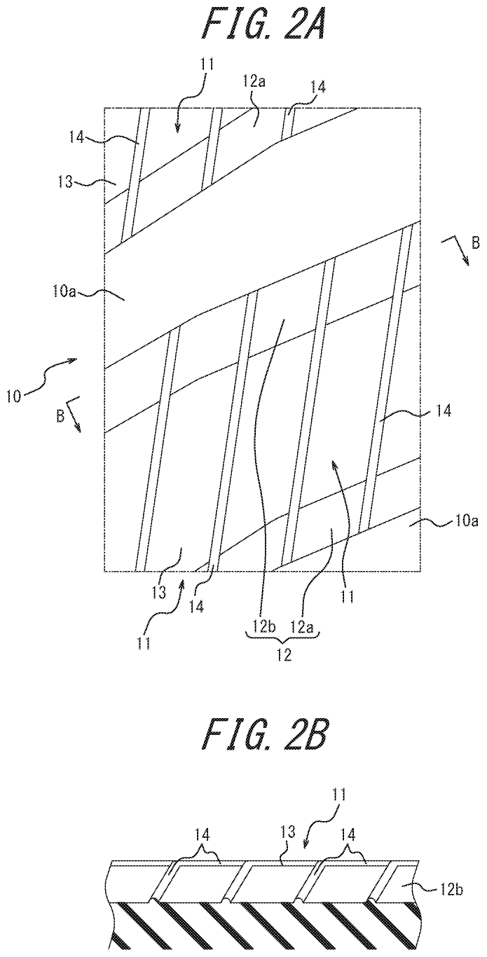

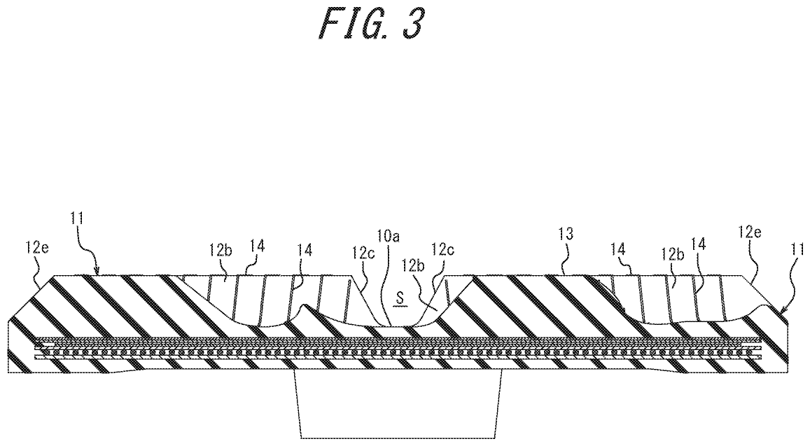

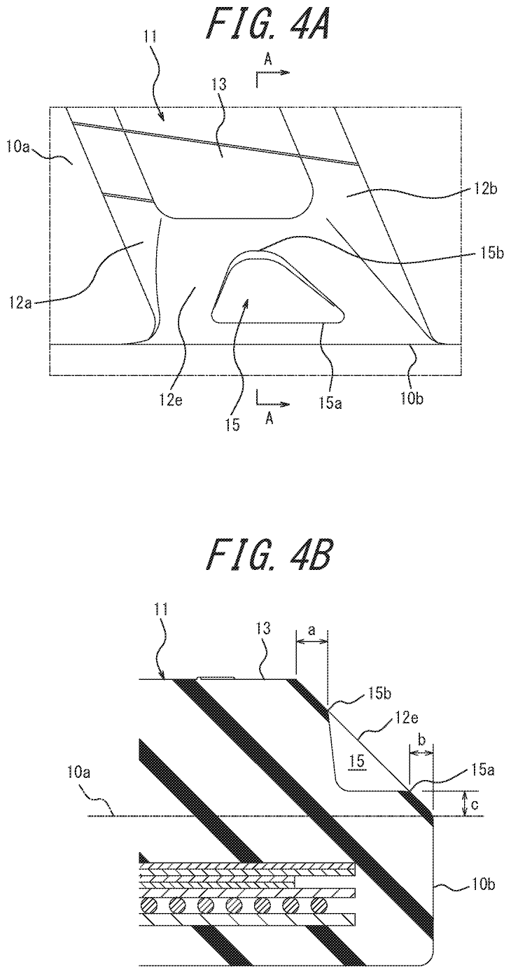

FIG. 1A is a perspective view illustrating, from the ground contact surface side, a portion cut in the crawler peripheral direction of a rubber crawler according to an embodiment of the present disclosure. FIG. 1B is a plan view illustrating, from the ground contact surface side, a portion cut in the crawler peripheral direction of a rubber crawler according to an embodiment of the present disclosure. FIG. 2A is a partial enlarged view illustrating an enlargement of portion X of FIG. 1B. FIG. 2B is a cross-sectional view along line B-B of FIG. 2A. FIG. 3 is a cross-sectional view along line A-A of FIG. 1B. FIG. 4A is a partial enlarged view illustrating an enlargement of portion Y of FIG. 1B. FIG. 4B is a cross-section along line A-A of FIG. 4A, illustrating an enlargement of portion Y of FIG. 1B.

As illustrated in FIGS. 1A and 1B, a rubber crawler 10 according to the present embodiment is configured as an endless, fixed-width rubber elastic body having convex lugs 11 formed at a predetermined pitch in the crawler peripheral direction on the outer peripheral surface (crawler outer peripheral surface). The rubber crawler 10 is mounted on a vehicle used in construction, civil engineering, farming, or the like and is driven by a driving force being transmitted thereto from a driving force generator provided in the vehicle.

In the present embodiment, the lugs 11 protrude from a crawler outer peripheral surface l0a that becomes the crawler running surface. Each lug 11 is convex, with a substantially trapezoidal cross-section in the crawler peripheral direction, and includes a peripheral surface 12, shaped as an inclined vertical wall that becomes narrower towards the top, and a ground contact surface (tread) 13, which is a substantially rectangular flat surface in plan view, at the apex (see FIGS. 1A and 1B). In the present embodiment, the lugs 11 are inclined at a predetermined angle relative to the crawler width direction in plan view and extend in the crawler width direction while bending so that the central portion in the crawler width direction has a greater inclination angle (see FIGS. 1A and 1B).

In the present embodiment, the plurality of the lugs 11 are provided in parallel at a predetermined pitch, in the crawler peripheral direction, across the entire crawler outer peripheral surface 10a in the crawler peripheral direction and are divided into two groups on either side of a groove-shaped space S that extends in the crawler peripheral direction at the crawler widthwise center in plan view. The groups are shifted by substantially half the pitch in the crawler peripheral direction and are substantially symmetrical in the crawler width direction (see FIGS. 1A and 1B).

Consequently, in the present embodiment, the lugs 11 are lined up on the crawler outer peripheral surface 10a at predetermined intervals in the crawler peripheral direction roughly in a v-shape (see FIGS. 1A and 1B) that opens towards the reverse direction, opposite from the forward direction (the downward direction on the page in FIGS. 1A and 1B), of the rubber crawler 10 as mounted on a vehicle. The lugs 11 are not limited to being arranged roughly in the above-described v-shape that opens towards the reverse direction of the rubber crawler 10 and may instead be arranged in the opposite direction, roughly in a v-shape that opens towards the forward direction of the rubber crawler 10.

The rubber crawler 10 in the present embodiment is a large-scale rubber crawler 10 in which the height of the lugs 11 from the crawler outer peripheral surface 10a is 40 mm or more and is a maximum of approximately 70 mm.

The present disclosure is particularly suitable for such large-scale rubber crawlers with lugs that are 40 mm or more, more preferably 50 mm or more.

In the present embodiment, the peripheral surface 12 includes a first side surface 12a and a second side surface 12b that face the crawler peripheral direction and bend in the crawler peripheral direction in correspondence with the shape of the ground contact surface 13, an inner first end surface 12c and inner second end surface 12d that face the crawler width direction, and an outer end surface 12e (see FIGS. 1A and 1B).

In the present embodiment, the first side surface 12a, the second side surface 12b, the inner first end surface 12c, and the inner second end surface 12d are formed to rise up from the crawler outer peripheral surface 10a via a curved surface protruding inwards (see FIG. 1A). The outer end surface 12e is formed to rise up straight from the crawler outer peripheral surface 10a. The inner first end surfaces 12c positioned on either side of the groove-shaped space S at the crawler widthwise center face each other while being shifted by substantially half the pitch in the crawler peripheral direction (see FIGS. 1A and 1B).

In the present embodiment, the first side surface 12a becomes the kick-in surface of the lug 11, and the second side surface 12b becomes the kick-out surface of the lug 11. The first side surface 12a, which is the kick-in surface, has a curved shape protruding forward in the crawler rotation direction relative to the lug 11 in a cross-sectional view from the crawler width direction (crawler widthwise cross-sectional view). In the present embodiment, the inner first end surface 12c, the inner second end surface 12d, and the outer end surface 12e are formed as flat surfaces.

The lugs 11 may have any shape and arrangement that achieve the objective of the present disclosure.

The rubber crawler 10 made of a rubber elastic body has, for example, members such as reinforcing cords configured by steel cords embedded therein in the present embodiment. The internal structure and the like of the rubber crawler 10 may, however, be freely chosen.

As illustrated in FIGS. 1A, 1B, 2A, 2B, and 3, a plurality of rows of minute protrusions (vent ridges) 14 are formed in the present embodiment on the side surfaces facing the crawler peripheral direction of the lugs 11, i.e. the first side surface 12a and the second side surface 12b. The minute protrusions 14 extend in a direction intersecting the crawler width direction when viewed from the crawler peripheral direction and are side-by-side in the crawler width direction (see FIGS. 2A, 2B, and 3). These minute protrusions 14 formed on the first side surface 12a and the second side surface 12b are also formed in the present embodiment as rows side-by-side in the crawler width direction on the ground contact surface 13 of the lugs 11, continuously with the first side surface 12a and the second side surface 12b (see FIGS. 1A, 1B, 2A, 2B, and 3).

Accordingly, in the present embodiment, a plurality of rows of ridge-shaped minute protrusions 14 extending continuously in the crawler peripheral direction on the first side surface 12a, the ground contact surface 13, and the second side surface 12b, which are the portion of the lug 11 protruding from the crawler outer peripheral surface 10a, are arranged on the lugs 11 at substantially equal intervals in the crawler width direction in plan view (see FIGS. 1A, 1B, 2A, 2B, and 3). The minute protrusions 14 are formed to protrude from each of the first side surface 12a, the ground contact surface 13, and the second side surface 12b, which are surfaces of the lug 11.

The minute protrusions 14 on the first side surface 12a and second side surface 12b need not be formed over the entire range of the peripheral surface 12 in the height direction from the crawler outer peripheral surface 10a, i.e. the lowest portion of the lug 11, to the ground contact surface 13, i.e. the highest portion. It suffices for at least a component to extend in the height direction of the peripheral surface 12 as viewed in the crawler peripheral direction. In the present embodiment, the minute protrusions 14 are also formed on the curved surface, in contact with the crawler outer peripheral surface 10a, that protrudes inwards. Formation of the minute protrusions 14 may be omitted at the curved surface, in contact with the crawler outer peripheral surface 10a, that protrudes inwards. The minute protrusions 14 need not be formed continuously across the first side surface 12a, ground contact surface 13, and second side surface 12b and may be formed instead only on the first side surface 12a, only on the first side surface 12a and the ground contact surface 13, only on the second side surface 12b, or only on the second side surface 12b and the ground contact surface 13.

At the time of vulcanization to form the rubber crawler 10 having the lugs 11 on which the minute protrusions 14 are formed, the minute protrusions 14 can be formed in the present embodiment by recesses provided in the mold in correspondence with the minute protrusions 14. When the minute protrusions 14 are formed by recesses provided in the mold, the recesses are preferably configured to communicate with an exhaust passage that opens to the outside of the mold. This configuration allows the recesses for forming the minute protrusions 14 to function as vents to discharge air from inside the rubber crawler mold to the outside of the mold at the time of vulcanization molding using the rubber crawler mold. Accordingly, to increase this effect of air release, the minute protrusions 14 are preferably also formed on the ground contact surface 13 and more preferably formed to be continuous from the first side surface 12a and/or the second side surface 12b to the ground contact surface 13, as in the present embodiment.

In the present embodiment, the minute protrusions 14 preferably have a width of 0.5 mm to 3 mm, more preferably 0.7 mm to 2 mm, and preferably have a height of 0.5 mm to 3 mm, more preferably 0.7 mm to 1 mm. Excessively narrow minute protrusions 14 risk a reduction in the effect of air release, whereas excessively wide minute protrusions 14 may become filled with rubber too early to achieve the function of air release. Excessively high minute protrusions 14 may, for example, catch in the mold during crawler production and cause damage, whereas excessively low minute protrusions 14 might not achieve a sufficient effect.

The minute protrusions 14 formed in a plurality of rows side-by-side in the crawler width direction on the first side surface 12a, the second side surface 12b, and the ground contact surface 13 are preferably formed along the crawler peripheral direction, but formation along the crawler peripheral direction is not necessary. The minute protrusions 14 may instead be inclined at a predetermined angle (for example, in a range of approximately ±20°) relative to the crawler peripheral direction (see FIGS. 1A, 1B, 2A, 2B, and 3). The minute protrusions 14 are inclined relative to the crawler width direction without becoming parallel to the crawler width direction. This is because minute protrusions 14 parallel to the crawler width direction might prevent removal from the mold at the time of vulcanization molding.

The distance between rows of the minute protrusions 14 is preferably 10 mm to 20 mm, more preferably 10 mm to 15 mm, in the present embodiment. Processing might become difficult if the distance between rows of the minute protrusions 14 is too short, whereas the effect of air release might be reduced if the distance is too long.

The first side surface 12a and second side surface 12b of the lugs 11 in the present embodiment are not limited to being an inclined surface formed by a single flat surface at a single inclination angle relative to the height direction of the lug 11 and may instead be a multi-step inclined surface formed by a plurality of flat surfaces or an inclined surface formed by an uneven curved surface, or may, for example, be a two-step inclined surface that includes a convex surface.

As illustrated in FIGS. 1A, 1B, 4A, and 4B, a recess 15 recessed inward in the crawler width direction is formed on the outer end surface 12e, i.e. the crawler widthwise outer end surface facing outward in the crawler width direction on the lug 11 that extends to a crawler widthwise end 10b. The outline of this recess 15 is separated from the outline of the outer end surface 12e by a predetermined distance, and the opening of the recess 15 is formed to have a substantially triangular shape (see FIG. 4A). In other words, the recess 15 opens within the outer end surface 12e at a predetermined distance away from the outline around the outer shape of the outer end surface 12e.

In the present embodiment, the outer end surface 12e with the recess 15 formed thereon is formed as an inclined surface that is connected to the crawler widthwise end 10b of the rubber crawler 10 and is inclined upward, i.e. towards the ground contact surface (tread) 13, at an angle of 40° to 80°, for example, relative to the crawler outer peripheral surface 10a (see FIG. 4B). Formation of the outer end surface 12e as an inclined surface in this way increases the flexibility of the crawler widthwise outer end portion of the lug 11.

In the present embodiment, the inclined outer end surface 12e is substantially trapezoidal, with an upper base along the ground contact surface (tread) 13, a lower base along the crawler outer peripheral surface 10a, and as viewed from the crawler width direction, one leg by the first side surface 12a, extending substantially perpendicularly to the crawler outer peripheral surface 10a, and another leg by the second side surface 12b, inclined towards the first side surface 12a relative to the crawler outer peripheral surface 10a (see FIG. 4A).

In the present embodiment, the crawler widthwise inner surface of the substantially triangular shape forming the opening of the recess 15 has a curved shape that protrudes inwards in the crawler width direction. Consequently, the recess 15 in the present embodiment has a substantially triangular shape in plan view, i.e. as seen from the ground contact surface (tread) 13, with a bottom 15a at the crawler outer peripheral surface 10a side and a curved apex 15b, having an arc-shaped cross section, that protrudes towards the ground contact surface (tread) 13 at the ground contact surface (tread) 13 side (see FIG. 4A). A concentration of stress at the apex 15b of the recess 15 can be avoided by forming the apex 15b as a curved surface protruding towards the ground contact surface (tread) 13.

In the present embodiment, the opening of the recess 15 has a substantially triangular shape. In conjunction with the asymmetrical shape of the lugs 11, which have different inclination angles on either side in the crawler peripheral direction, the substantially triangular shape of the opening may also be asymmetrical in plan view, with different inclination angles on either side in the crawler peripheral direction.

The length, in the crawler peripheral direction, of the bottom 15a of the substantially triangular recess 15 in the present embodiment is, for example, 0.4 to 0.7 times the contact length, in the crawler peripheral direction, of the lug 11 with the crawler outer peripheral surface 10a, i.e. the bottom length of the lug 11. The length, in the crawler peripheral direction, of the curved portion of the apex 15b is, for example, 0.1 to 0.3 times the length, in the crawler peripheral direction, of the ground contact surface (tread) 13, which is the top surface of the lug 11.

The crawler widthwise cross-sectional shape of the recess 15 of the present embodiment is substantially triangular. In an example of the substantially triangular shape in a crawler widthwise cross-section, the base is a portion of the inclined outer end surface 12e, and the sides are formed by a side along the lug protrusion direction, which is the height direction, and a side along the crawler outer peripheral surface 10a, which is the depth direction (see FIG. 4B).

In the present embodiment, the ratio of the length of the side in the depth direction to the length of the side in the height direction in the recess 15 with a substantially triangular crawler widthwise cross-section is preferably 1 to 0.8-1.2, more preferably 1 to 1. The angle of the apex of the recess 15 with a substantially triangular crawler widthwise cross-section is preferably 80° to 100°, more preferably 90°.

The crawler widthwise cross-sectional shape of the recess 15 is substantially an isosceles triangle, with substantially equal length sides in the height direction and the depth direction. This configuration can achieve a good balance between suppressing an increase in rigidity of the crawler widthwise edge and improving durability.

The crawler widthwise cross-sectional shape of the recess 15 is not limited to being substantially an isosceles triangle, with substantially equal length sides in the height direction and the depth direction. The recess 15 may instead have a substantially triangular shape in which the side in the height direction is longer or shorter than the side in the depth direction.

The outline of the recess 15 that is substantially triangular at the ground contact surface (tread) 13 side is separated from the outline of the outer end surface 12e, which is substantially trapezoidal at the ground contact surface (tread) 13 side as when viewed from the crawler width direction, by a crawler widthwise distance a of 3-6 mm, for example, at the upper end of the recess 15 and a crawler widthwise distance b of 3-6 mm, for example, at the lower end of the recess 15. The outline of the recess 15 is also separated from the crawler outer peripheral surface 10a at the lower end of the recess 15 by a lug protrusion direction distance c of 3-6 mm, for example.

In other words, the recess 15 is disposed upwards (in the lug protrusion direction) from the crawler outer peripheral surface 10a at a lug protrusion direction distance c of 3-6 mm, for example, from the bottom of the lug 11, i.e. the crawler outer peripheral surface 10a (see FIG. 4B).

In this way, the outer end surface 12e, which is the crawler widthwise outer end surface facing outward in the crawler width direction, of the lug 11 is formed as an inclined surface continuous with the crawler widthwise end 10b (see FIG. 4B). The width of the lug 11 in the crawler width direction can thus be expanded all the way to the crawler widthwise end 10b of the rubber crawler 10 without provision of ears, i.e. crawler widthwise edges, in the rubber crawler 10 (see FIGS. 1A, 1B, 4A, and 4B). This improves the durability of the rubber crawler 10.

Furthermore, provision of the recess 15 on the outer end surface 12e of the lug 11 can suppress an increase in rigidity of the crawler widthwise outer end of the lug 11 even if the width of the lug 11 in the crawler width direction is expanded. Additionally, when the recess 15 has the above-described configuration, a concentration of stress at the crawler widthwise outer end of the lug 11 can be prevented, ensuring durability at the crawler widthwise outer end of the lug 11.

In a large-scale rubber crawler in which the lugs 11 have a height of 40 mm or more, in particular 50 mm or more, from the crawler outer peripheral surface 10a, the lugs become entangled at the road surface side of the rubber crawler when the vehicle turns while driving on a road, and rubber strain increases near the steel cords embedded inside the rubber crawler, leading to cracks in the lugs. As a result of the above-described configuration, such cracking can be suppressed insofar as possible, which also reduces the occurrence of defects in appearance.

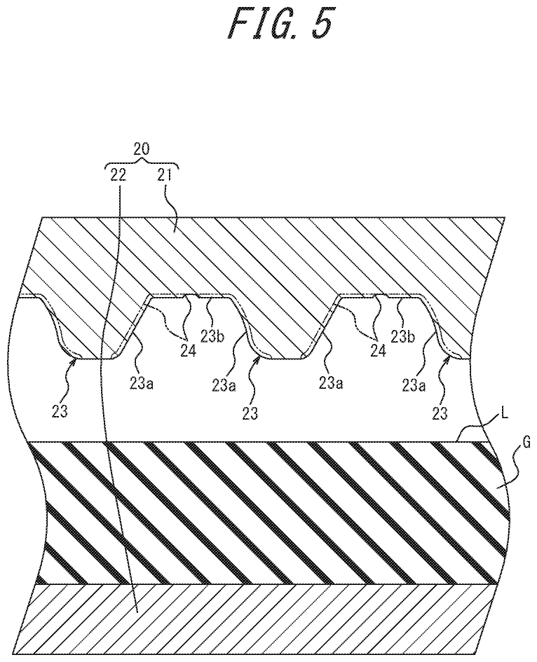

FIG. 5 is a partial cross-section illustrating an upper mold piece and a lower mold piece of a rubber crawler mold according to an embodiment of the present disclosure.

As illustrated in FIG. 5, a rubber crawler mold 20 according to the present embodiment includes an upper mold piece 21 and a lower mold piece 22 and is used to obtain the rubber crawler 10 by pressing the upper mold piece 21 and an unvulcanized rubber member G, placed between the upper mold piece 21 and lower mold piece 22, relative to each other (pressing the unvulcanized rubber member G with the upper mold piece 21 in the present embodiment) and vulcanizing a lug surface L.

The rubber crawler mold 20 described in the example below is for producing the rubber crawler 10 according to the present embodiment as described above using FIGS. 1A, 1B, 2A, 2B, 3, 4A, and 4B.

In the present embodiment, the upper mold piece 21 includes lug molding blocks 23 for forming the protruding lugs 11 on the lug surface L of the unvulcanized rubber member G and recesses (minute recesses) 24 on lug side-surface forming portions 23a of the lug molding blocks 23 (see FIG. 5). The lug side-surface forming portions 23a are for forming the first side surface 12a and the second side surface 12b (see FIGS. 1B, 2A, 2B, 3, and 4A), of the lug 11, that face in the crawler circumferential direction. These recesses 24 form the minute protrusions 14 (see FIGS. 2A, 2B, and 3) on the first side surface 12a and second side surface 12b of the lugs 11 of the rubber crawler 10.

The recesses 24 communicate with an exhaust passage (not illustrated) opening to the outside of the rubber crawler mold 20 and function as vents to discharge air from inside the rubber crawler mold 20 to the outside at the time of vulcanization molding using the rubber crawler mold 20 of the present embodiment.

The lug molding blocks 23 of the upper mold piece 21 may be separate bodies that are integrated by being bolted or the like. In this case, the minute gaps that occur when the separate lug molding blocks 23 are assembled can also function as discharge passages to discharge air.

To improve the effect of air release, the recesses 24 in the present embodiment are formed not only on the lug side-surface forming portions 23a but also in the same way on lug ground contact surface forming portions 23b that form the ground contact surface 13 of the lugs 11 of the rubber crawler 10 and are configured by groove-shaped recesses between adjacent lug molding blocks 23 on the upper mold piece 21 (see FIG. 5). In the present embodiment, the recesses 24 formed on the lug ground contact surface forming portions 23b communicate and are formed integrally with the recesses 24 formed on the lug side-surface forming portions 23a (see FIG. 5) and communicate with an exhaust passage (not illustrated) opening to the outside of the rubber crawler mold 20.

The recesses 24 may be formed without causing the lug side-surface forming portions 23a and the lug ground contact surface forming portions 23b to communicate, or may be formed only on the lug side-surface forming portions 23a, only on the lug side-surface forming portions 23a and the lug ground contact surface forming portions 23b, or only on the lug ground contact surface forming portions 23b. To improve the below-described effect of air release, however, the recesses 24 are preferably formed also on the lug ground contact surface forming portions 23b, as in the present embodiment, and are more preferably formed so that the lug side-surface forming portions 23a and the lug ground contact surface forming portions 23b communicate.

A method, according to an embodiment of the present disclosure, of producing a rubber crawler to obtain the rubber crawler 10 by vulcanization using the rubber crawler mold 20 according to the present disclosure is described next.

In the present embodiment, when producing a rubber crawler including an endless rubber elastic body and protruding lugs formed on an outer peripheral surface at a predetermined pitch in a crawler peripheral direction, an unvulcanized rubber member G that includes a lug surface is placed between the upper mold piece 21 and the lower mold piece 22 of the rubber crawler mold 20 according to the present disclosure, and the upper mold piece 21 are pressed relative to each other (the unvulcanized rubber member G is pressed by the upper mold piece 21 in the present embodiment), and the lug surface is vulcanized to obtain the rubber crawler 10.

As the upper mold piece 21 moves towards the lower mold piece 22, the lug molding blocks 23 gradually enter, from the tips thereof, into the unvulcanized rubber member G mounted in the lower mold piece 22. As a result, the air between the upper mold piece 21 and the unvulcanized rubber member G during pressing by the upper mold piece 21 passes through the recesses 24 formed on the lug side-surface forming portions 23a of the lug molding blocks 23 and moves to above the lug molding blocks 23.

In other words, in the present embodiment, the air inside the mold 20 rises up and escapes through the space formed by the recesses 24 between the unvulcanized rubber member G and the lug side-surface forming portions 23a of the lug molding blocks 23 in close contact with the unvulcanized rubber member G.

Furthermore, air inside the mold 20 rises towards the lug ground contact surface forming portions 23b of the upper mold piece 21 before pressing of the unvulcanized rubber member G by the upper mold piece 21 proceeds and the lug ground contact surface forming portions 23b of the upper mold piece 21 come into close contact with the unvulcanized rubber member G. This air enters and escapes through the recesses 24 (see FIG. 5) formed on the lug ground contact surface forming portions 23b integrally in connection with the recesses 24 formed on the lug side-surface forming portions 23a. The air then passes through an exhaust passage (not illustrated) opening to the outside of the rubber crawler mold 20 and is discharged outside the rubber crawler mold 20.

The lug ground contact surface forming portions 23b of the upper mold piece 21 then achieve close contact with the unvulcanized rubber member G, and the unvulcanized rubber member G is vulcanized to obtain the rubber crawler 10. Consequently, during pressing of the unvulcanized rubber member G by the upper mold piece 21, the minute protrusions 14 are formed on the first side surface 12a and the second side surface 12b of the lugs 11 by the unvulcanized rubber member G that entered the recesses 24 formed on the lug side-surface forming portions 23a, and the minute protrusions 14 are formed on the ground contact surface 13 of the lugs 11 by the unvulcanized rubber member G that entered the recesses 24 formed on the lug ground contact surface forming portions 23b.

As described above, the recesses 24 formed in the lug side-surface forming portions 23a and the recesses 24 formed in the lug ground contact surface forming portions 23b both function as vents to discharge air from inside the rubber crawler mold 20 to the outside at the time of vulcanization molding. For vulcanization molding, the upper mold piece 21 and the lower mold piece 22 may be heated to a high temperature as necessary.

In this way, when the unvulcanized rubber member G is pressed by the upper mold piece 21 to vulcanize the lug surface of the rubber crawler 10 using the rubber crawler mold 20, the air inside the mold 20 can be actively released from the inside to the outside of the mold 20 (upper mold piece 21), through the recesses 24 formed in the lug side-surface forming portions 23a and the lug ground contact surface forming portions 23b of the upper mold piece 21, without being kept inside the mold 20 (upper mold piece 21).

In particular, by formation of the recesses 24 in the lug side-surface forming portions 23a, air inside the mold 20 can reliably be released at the time of vulcanization molding even in the large-scale rubber crawler 10 with lugs 11 that protrude to a great height of 40 mm or more, in particular 50 mm or more, from the crawler outer peripheral surface 10a to the ground contact surface (top portion) 13. The reason is that even if the distance to the top surface of the lug increases due to the lugs 11 protruding to a greater height, causing the distance over which air moves at the first side surface 12a and the second side surface 12b of the lug 11 at the time of vulcanization molding to increase, a flow path for movement of air can still be guaranteed by the recesses 24 formed in the lug side-surface forming portions 23a.

A large-scale rubber crawler 10 that has lugs 11 protruding to a height of 40 mm or more, in particular 50 mm or more, tends to have molding defects caused by air trapping, flow failure, or the like due to the air in the mold 20 not completely escaping at the time of vulcanization molding. However, even for such a large-scale rubber crawler, formation by vulcanization molding in which the unvulcanized rubber member G is pressed using the mold 20 can prevent these molding defects. In other words, air can be released reliably from inside the mold 20, and molding defects occurring due to air not being released can be suppressed.

As described above, a rubber crawler, a rubber crawler mold, and a method of producing a rubber crawler according to an embodiment of the present disclosure can suppress molding defects at the time of production of the rubber crawler 10 by vulcanization molding using the mold 20 and can therefore reduce the occurrence of defects in appearance due to molding defects. In the case of a large-scale rubber crawler 10 of a certain size, the number of molding defects, and therefore defects in appearance, per unit number was reduced to approximately ⅓ for products of the present disclosure according to the above embodiment, as compared to conventional products in which the minute protrusions 14 were formed only on the ground contact surface 13 of the lugs 11 by a mold 20 provided with recesses 24 only on the lug ground contact surface forming portions 23b.

Furthermore, as compared to when the minute protrusions 14 are not formed, formation of the minute protrusions 14 on the side surfaces of the lugs 11 can improve the mud separation and the traction when the rubber crawler 10 is driven.

The rubber crawler 10 of the present disclosure can suitably be produced by the method of producing a rubber crawler of the present disclosure, using the rubber crawler mold 20 of the present disclosure.

### REFERENCE SIGNS LIST

10 Rubber crawler

10a Crawler outer peripheral surface

11 Lug

12 Peripheral surface

12a First side surface

12b Second side surface

12c Inner first end surface

12d Inner second end surface

12e Outer end surface

13 Ground contact surface

14 Minute protrusion

15 Recess

15a Bottom

15b Apex

20 Rubber crawler mold

21 Upper mold piece

22 Lower mold piece

23 Lug molding block

23a Lug side-surface forming portion

23b Lug ground contact surface forming portion

24 Recess

S Groove-shaped space

G Unvulcanized rubber member

L Lug surface

1. A rubber crawler comprising an endless rubber elastic body and protruding lugs formed on an outer peripheral surface at a predetermined pitch in a crawler peripheral direction;
wherein minute protrusions extending in a direction intersecting a crawler width direction when viewed from the crawler peripheral direction are formed on a side surface of the lugs, the side surface facing the crawler peripheral direction.

2. The rubber crawler of claim 1, wherein the minute protrusions are formed on a ground contact surface of the lugs.

3. The rubber crawler of claim 2, wherein the minute protrusions on the side surface of the lugs and the minute protrusions on the ground contact surface of the lugs are formed continuously.

4. A rubber crawler mold, comprising an upper mold piece and a lower mold piece, for obtaining a rubber crawler by placing an unvulcanized rubber member that includes a lug surface between the upper mold piece and the lower mold piece, pressing the upper mold piece and the unvulcanized rubber member relative to each other, and vulcanizing the lug surface;
wherein the upper mold piece comprises lug molding blocks for forming protruding lugs on the lug surface, the lug molding blocks comprise lug side-surface forming portions for forming side surfaces of the lugs, the side surfaces facing a crawler peripheral direction, and minute recesses are provided on the lug side-surface forming portions.

5. The rubber crawler mold of claim 4, wherein minute recesses are provided on lug ground contact surface forming portions for forming a ground contact surface of the lugs.

6. A method of producing a rubber crawler comprising an endless rubber elastic body and protruding lugs formed on an outer peripheral surface at a predetermined pitch in a crawler peripheral direction, the method comprising:
placing an unvulcanized rubber member that includes a lug surface between the upper mold piece and the lower mold piece of the rubber crawler mold of claim 4 or 5, pressing the upper mold piece and the unvulcanized rubber member relative to each other, and vulcanizing the lug surface to obtain the rubber crawler.

7. A method of producing a rubber crawler comprising an endless rubber elastic body and protruding lugs formed on an outer peripheral surface at a predetermined pitch in a crawler peripheral direction, the method comprising:
placing an unvulcanized rubber member that includes a lug surface between the upper mold piece and the lower mold piece of the rubber crawler mold of claim 5, pressing the upper mold piece and the unvulcanized rubber member relative to each other, and vulcanizing the lug surface to obtain the rubber crawler.
